(19) United States
(12) Patent Application Publication
(10) Pub. No.: US 2010/0052867 A1
(43) Pub. Date: Mar. 4, 2010

(54) APPARATUS AND METHOD FOR IDENTIFYING OBJECT MOVEMENT AND LOCATION WITH RFID DEVICE

(75) Inventors: Siu Keung Kwok, Hong Kong (CN); Chi Fai Cheung, Hong Kong (CN); Hing Choi Tsang, Hong Kong (CN); Wing Bun Lee, Hong Kong (CN); Burly K. Tan, Hong Kong (CN); Jay Lee, Hong Kong (CN); Pui Him Ng, Hong Kong (CN); Sze Kit Ho, Hong Kong (CN)

Correspondence Address: SCHWABE, WILLIAMSON & WYATT, P.C., 1420 FIFTH, SUITE 3010, SEATTLE, WA, 98101, US

(73) Assignee: THE HONG KONG POLYTECHNIC UNIVERSITY, Hong Kong (CN)

(21) Appl. No.: 12/523,979

(22) PCT Filed: Jan. 15, 2008
(86) PCT No.: PCT/CN2008/000098

§ 371 Date: Oct. 29, 2009

(30) Foreign Application Priority Data
Jan. 24, 2007 (HK) 07100834.3

(51) Int. Cl. H04Q 5/22

(52) U.S. Cl. 340/10.42; 340/572.1

(57) ABSTRACT

An apparatus for identifying object movement and location with RFID device comprises two RFID gateways constructed by at least one RFID interrogator located inside and outside an entrance of a monitored zone independently, a portable RFID tag carried by the object capable of receiving and responding said signals emitted by said RFID interrogator, and a data processor connected with said RFID gateways capable of receiving said responses to identify said object movement as leaving or entering said entrance and said object location as outside or inside said monitored zone. There is also a corresponding method for identifying object movement and location with RFID device.

### FIELD OF THE INVENTION

The present invention pertains to RFID (Radio Frequency Identification) field, especially to object tracking technology with RFID device. More particularly, this invention relates to an apparatus and method for identifying object movement and location with RFID device.

### BACKGROUND OF THE INVENTION

At the moment, a barcode can be used to track participants when they enter an area via an entrance of the area, but the barcode cannot be used to keep tracking where the participants go. However, a RFID device can be used to keep tracking of objects and goods when they are in the RFID covered zones. Successful object tracking mainly depends on the accuracy of captured data of objects' location, and therefore RFID device deployment acts as a critical role on the accuracy of the captured data for object tracking, no matter using active RFID technologies or using passive RFID technologies.

The prior art of using passive RFID for object tracking is mainly using one RFID gateway at one entrance of a room for RFID tag tracking. In other words, all RFID interrogators (including RFID reader and RFID antenna) are defined in a same configuration (i.e. in a same type of RFID setup), no matter how many readers and antennas are deployed, and they should be considered as one RFID gateway. For example, as shown in FIG.1, two RFID interrogators 120-1/120-2 are located at one entrance 210 of a room 200 in a same type of RFID setup and form a RFID gateway 100 jointly. By checking the location of a RFID tag 130 worn on a person and changing its status, the person will be identified as inside (IN) or outside (OUT) said room 200. More detailed, said RFID tag 130 is detected by the RFID interrogator 120 as soon as the person enters a predefined interrogation zone 110 of the RFID gateway 100 via a predefined walking path 300, and then the location status of the RFID tag 130 will change from previous “IN” to current “OUT”, or from previous “OUT” to current “IN”.

The above mentioned prior approach is typically used for object tracking of asset management application in supply chain. The objects of asset management are items/products/goods which follow the predefined walking path 300 of production or logistics flows. So these objects pass through the entrance 210 (i.e. the interrogation zone 110 of the RFID gateway 100) in one direction only and they are prohibited to stop/hover in front of the entrance 210 (i.e. the interrogation zone 110 of the RFID gateway 100) at the same time. Hence the location status of the objects is always checked and changed accurately and effectively.

However, the above mentioned prior approach has critical limitation while it is used for personnel tracking, because personnel could not be forced to follow the predefined walking path 300. Since personnel are free to walk into different rooms and location through different paths, if the personnel who is carrying a RFID tag 130 with “OUT” status walks and stops in front of the entrance 210, and then his/her status will be changed to “IN” as soon as he/she is identified by the RFID interrogator 120 of the RFID gateway 100, no matter he/she enters into the room 200 or returns to the original location. Therefore, it would become a major error as said personnel having the opposite status when he/she is out of the room 200 later.

### SUMMARY OF THE INVENTION

In view of the problem of the prior art, the objective of the present invention is to provide an apparatus and method for identifying object movement and location with RFID device. Said apparatus and method enable to detect real time movement direction and location status of every personnel object with high accuracy while they are presenting in a particular monitored zone, and so as to collect accurately personnel location information for managing some activity, such as a seminar, a conference, an exhibition, a workshop, a show, or etc.

In order to attain the above objective, the present invention provides an apparatus for identifying object movement and location with RFID device. Said apparatus comprises two RFID gateways located inside and outside an entrance of a monitored zone independently, a portable RFID tag carried by said object, and a data processor connected with said RFID gateways.

For said two RFID gateways, wherein, the first said RFID gateway is constructed by at least one RFID interrogator and forms a corresponding first interrogation zone inside said entrance, while the second said RFID gateway is constructed by at least one RFID interrogator and forms a corresponding second interrogation zone outside said entrance. And each said RFID interrogator emits a signal comprising a unique identifier associated with its corresponding RFID gateway.

Said portable RFID tag capable of receiving said signals emitted by said RFID interrogator, and comprises means for reflecting back a response to said RFID interrogator according to the identifier of the received signal. And said response reflected by said RFID tag comprises a unique code associated with said RFID tag.

Said data processor capable of receiving the responses transmitted by said RFID interrogator, and comprises means for processing the received response to determine which of said RFID gateway detecting said RFID tag at the time of the reception thereof, and analyzing the time of said first RFID gateway detecting said RFID tag earlier or later than said second RFID gateway to conclude said object movement as leaving or entering said entrance and said object location as outside or inside said monitored zone.

At the same time, the present invention provides a corresponding method for identifying object movement and location with RFID device. Said method comprises the following steps:

A. assigning the first and second RFID gateway a unique identifier independently;

B. locating at least one RFID interrogator associated with said first RFID gateway to establish corresponding first interrogation zone inside an entrance of a monitored zone, and locating at least one RFID interrogator associated with said second RFID gateway to establish corresponding second interrogation zone outside said entrance;

C. having said RFID interrogator emit signals comprising said unique identifier for reception by a portable RFID tag carried on the object;

D. reflecting back a response comprising a unique code associated with said RFID tag to said RFID interrogator according to the identifier of said received signal;

E. processing said response to determine which of said RFID gateway detecting said RFID tag at the time of the reception thereof;

F. analyzing the time of said first RFID gateway detecting said RFID tag earlier or later than said second RFID gateway to conclude said object movement as leaving or entering said entrance and said object location as outside or inside said monitored zone.

These and other features, aspects, and embodiments of the present invention are described below in the section entitled “Detailed description of the invention.”

### BRIEF DESCRIPTION OF THE DRAWINGS

FIG. 1 is a schematic view of RFID gateway setting in accordance with the prior art;

FIG. 2 is a schematic view of RFID gateway setting in accordance with an embodiment of the present invention;

FIG. 3 illustrates an example of one RFID interrogator and gateway mounting that may be used in the method shown in FIG. 2;

FIG. 4 illustrates another example of one RFID interrogator and gateway mounting that may be used in the method shown in FIG. 2;

FIG. 5 is a flow diagram of identifying object movement and location in accordance with an embodiment of the method provided by the present invention.

### DETAIL DESCRIPTION OF PREFERRED EMBODIMENT(S)

Generally, the present invention provides an apparatus and method for identifying object movement direction and location status with RFID device. Said apparatus and method are invented for real time personnel tracking nearby an entrance of a particular monitored room, and further for improving the management of some activity such as a seminar, a show, or etc.

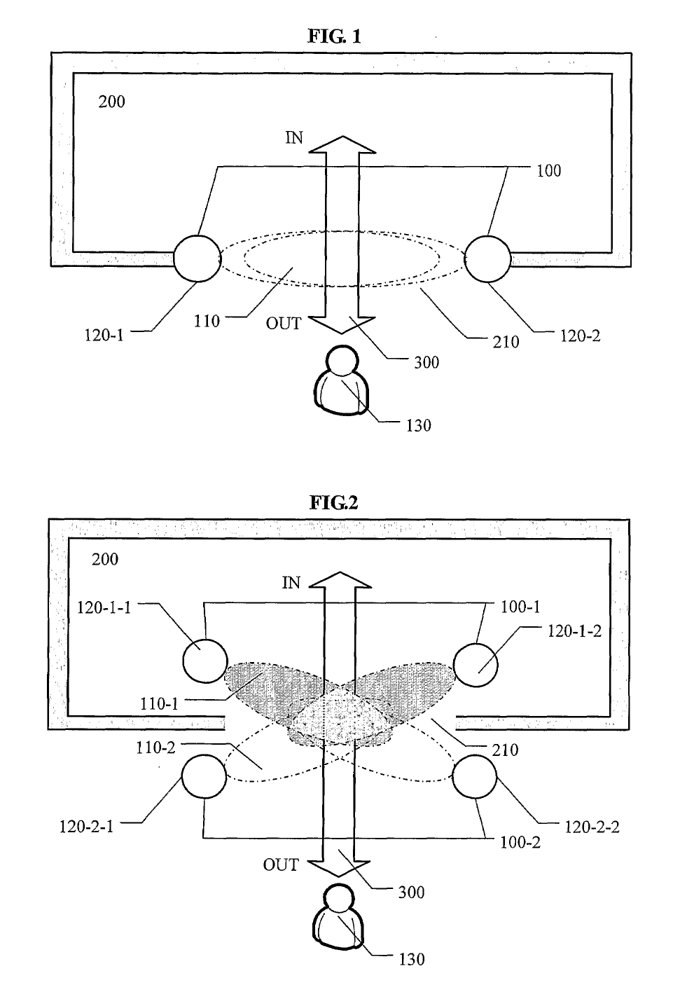

As described in the section entitled “Background of the invention”, the prior art of tracking with RFID device is typically using one RFID gateway (see FIG. 1), and this prior approach doesn't suit to personnel tracking as well as item/object tracking in assert management applications. Therefore, in order to enhance the accuracy of personnel tracking records, the focus of the present invention is to improve the setting of RFID gateway with RFID device (including RFID readers and antennas).

An embodiment of said apparatus for identifying object movement and location nearby according to the present invention comprises two RFID gateways, a portable RFID tag, and a data processor.

Said two RFID gateways are constructed by at least one RFID interrogator independently. Wherein, the first said RFID gateway forms a corresponding first interrogation zone inside an entrance of a particular monitored zone, while the second said RFID gateway forms a corresponding second interrogation zone outside said entrance. And each said RFID interrogator emits a signal comprising a unique identifier associated with its corresponding RFID gateway.

Said portable RFID tag is carried by the object and capable of receiving said signals emitted by said RFID interrogator, and comprises means for reflecting back a response to said RFID interrogator according to the identifier of said received signal. And said response reflected by said RFID tag comprises a unique code associated with said RFID tag.

Said data processor is connected with said two RFID gateways and capable of receiving the responses transmitted by said RFID interrogator, and comprises means for processing the received response to determine which of said RFID gateway detecting said RFID tag at the time of the reception thereof, and analyzing the time of said first RFID gateway detecting said RFID tag earlier or later than said second RFID gateway to conclude said object movement as leaving or entering said entrance and said object location as outside or inside said monitored zone. In other words, said data processor identifies the direction of said object movement by comparing the time of said two RFID gateways detecting said RFID tag, and determines the status of said object location by checking which of said two RFID gateways detecting the last presence of said RFID tag.

One skilled in the art can appreciate that said data processor may be an application software operated by a controlling host according to the identifying configuration of said two RFID gateways and said portable RFID tag, or may be any processor in other forms with the above stated functions.

One skilled in the art can also appreciate that said data processor can be connected with said two RFID gateways via a RFID middleware. Said RFID middleware manages said RFID interrogators associated with each of said two RFID gateways and filters the captured RFID data (including signals emitted by said RFID interrogator and responses reflected by said RFID tag), and then sends the filtered RFID data to said data processor. Once said data processor receives said filtered RFID data from said RFID middleware, it processes the filtered RFID data based on the predefined configurations specified according to the setting of said two RFID gateways to identify the direction of object movement and detect the status of object location accurately.

One skilled in the art can also appreciate that said data processor may preferably further comprise statistical means for counting the number of said objects associated with inside or outside said particular monitored zone independently, and so on. And thereby useful real time personnel objects tracking information would be generated for improving some activity (such as an exhibition, a workshop, and etc.) management.

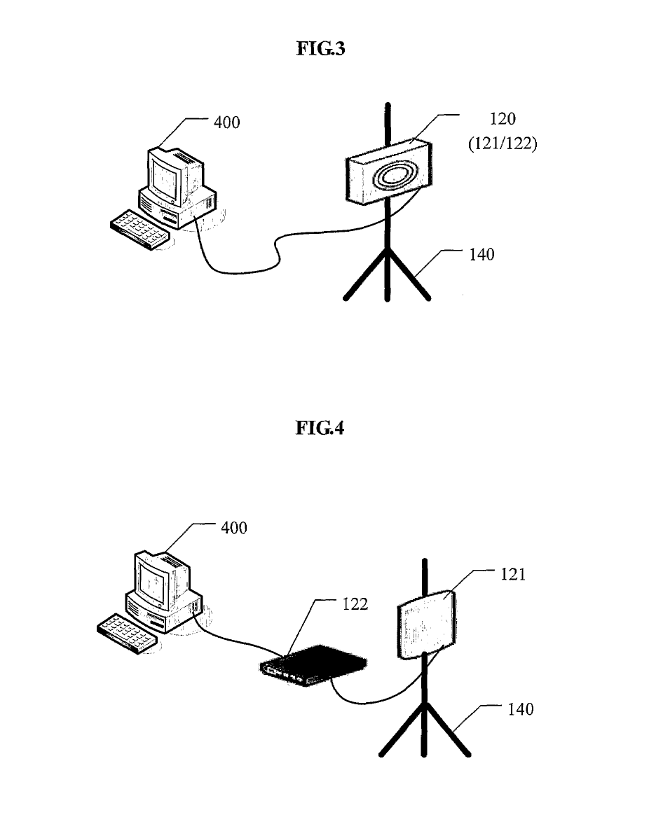

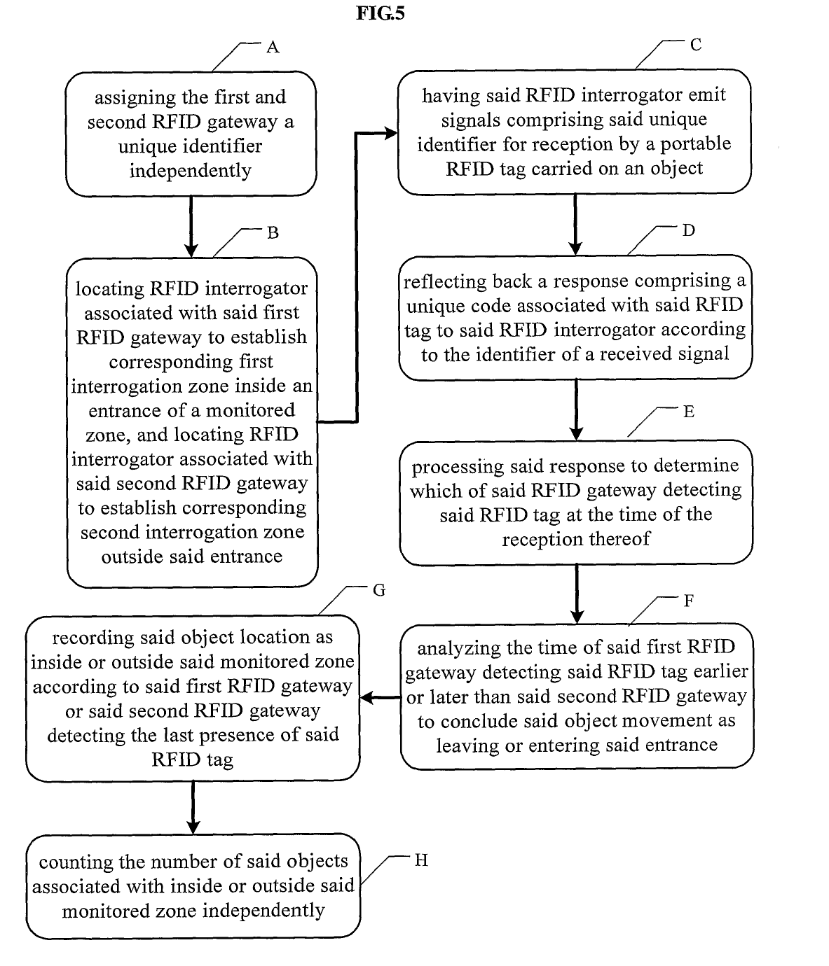

Referring to some accompanying drawings FIG. 2, FIG. 3 and FIG. 4, the structure of the above said apparatus will be detailed as follows.

FIG. 2 illustrates an example of said two gateway setting in accordance with an embodiment of the present invention. And as shown in FIG. 2, said two RFID gateways (including the first RFID gateway 100-1 and the second RFID gateway 100-2) are deployed nearby an entrance 210 of a room (i.e. a particular monitored zone) 200 for identifying object movement, and they are constructed by two RFID interrogators 120-1/120-2 independently. More detailed, the first RFID gateway 100-1 is constructed by two RFID interrogators 120-1-1/120-1-2 and establishes its corresponding first interrogation zone 110-1 inside said entrance 210 of the room 200, while the second RFID gateway 100-2 is constructed by two RFID interrogators 120-2-1/120-2-2 and establishes its corresponding second interrogation zone 110-2 outside said entrance 210 of the room 200.

For convenience of description, there are two RFID interrogators 120-1-1/120-1-2 120-2-1/120-2-2 employed in each of said two RFID gateways 100-1/100-2 independently as shown in FIG. 2. Actually, one or more than two RFID interrogators could also be employed. In general, more RFID interrogators will establish an interrogation zone 110-1/110-2 with larger coverage, and hereby the accuracy of identification will be improved by increasing systematic tolerance against various object walking paths 300. In another hand, more RFID interrogators 120 result more expensive deployment cost. As a result, in order to attain a better balance between the accuracy and the cost, an optimal number of the RFID interrogators sets should be selected carefully. However, said optimal number depends closely on lots of factors, including environmental factors of the monitored room 200, physical limitations of the RFID interrogators 120, and even object walking patterns 300.

Preferably, as shown in FIG. 3 and FIG. 4, each above stated RFID interrogator 120 consists of at least one RFID reader 121 and RFID antenna 122 independently. And said RFID interrogator may be an integrated RFID reader 120(121/122) (i.e. all-in-one RFID reader with RFID antenna) as illustrated in FIG. 3, or a separated module (i.e. one RFID reader 121 with at least one RFID antenna 122) as illustrated in FIG. 4, or etc. The RFID interrogator 120 emits signals to communicate with portable RFID tags 130. The RFID interrogator 120 decodes responses reflected by the RFID tag 130 and transports the decoded data to a controlling host 400. However, the application software on the controlling host 400 processes the data received from the RFID interrogator 120(121/122) to filter numerous redundant data for selecting out accurate location information, and may perform various operations to apply the useful accurate location information for managing an activity (such as a show, a conference, or etc.) based on some predefined configurations.

At the same time, each above stated RFID interrogator 120 is fixed and attached on a gateway mounting 140 with preferable location and orientation. The form of said gateway mounting 140 can be a tripod stand mounting as shown in FIG. 3 and FIG. 4, or an overhand mounting, or any others physical location and orientation fixtures to place the RFID interrogator 120.

This RFID gateway setting as shown in FIG. 2 can identify the direction of object movement accurately even though he/she is hovering between the two RFID gateways 100-1/100-2, and so as to detect object location with high accuracy. For example, if a person is walking towards the room 200 from the second RFID gateway 100-2 to the first RFID gateway 100-1, the second RFID gateway 100-2 will detect the RFID tag 130 carried by the object firstly and then the first RFID gateway 100-1 will detect the RFID tag 130 afterwards, and as result the object will be identified as entering the room 200. In this way, the movement of an object can be identified accurately by analyzing the time of said first RFID gateway 100-1 detecting said RFID tag 130 earlier or later than said second RFID gateway 100-2 to conclude said object movement as leaving or entering said entrance 210, and the location status of the object can be tracked as inside (IN) or outside (OUT) the room 200 accordingly.

Summarizing the above stated, the identifying configuration of the setting as shown in FIG. 2 should be abstracted as follows: the movement for entering the room 200 via the entrance 210 is identified as the first RFID gateway 100-1 detects the RFID tag 130 later than the second RFID gateway 100-2, the movement for leaving the room 200 via the entrance 210 is identified as the first RFID gateway detects the RFID tag 130 earlier than the second RFID gateway 100-2, the location of inside the room 200 is identified as the last presence of the RFID tag 130 is detected by the first RFID gateway 100-1, and the location of outside the room 200 is identified as the last presence of the RFID tag 130 is detected by the second RFID gateway 100-2.

As shown in FIG. 5, a preferable embodiment of the method provided by the present invention for identifying object movement and location with RFID device comprises the following steps:

A. assigning the first and second RFID gateway a unique identifier independently;

B. locating at least one RFID interrogator associated with said first RFID gateway to establish corresponding first interrogation zone inside an entrance of a particular monitored zone, and locating at least one RFID interrogator associated with said second RFID gateway to establish corresponding second interrogation zone outside said entrance;

C. having said RFID interrogator emit signals comprising said unique identifier for reception by a portable RFID tag carried on the object;

D. reflecting back a response comprising a unique code associated with said RFID tag to said RFID interrogator according to the identifier of said received signal;

E. processing said response to determine which of said RFID gateway detecting said RFID tag at the time of the reception thereof;

F. analyzing the time of said first RFID gateway detecting said RFID tag earlier or later than said second RFID gateway to conclude said object movement as leaving or entering said entrance;

G. recording said object location as inside or outside said particular monitored zone according to said first RFID gateway or said second RFID gateway detecting the last presence of said RFID tag;

H. counting the number of said objects associated with inside or outside said particular monitored zone independently.

For the above mentioned method, wherein, above step A and B is operated for setting said two RFID gateways 100-1/100-2 as shown in FIG. 2; above step C and D describe the interaction between said RFID interrogator 120 and said RFID tag 130 carried by an object; above step E and F explain said data processor how to process a response reflected by said RFID tag 130 to identify the direction of object movement nearby said entrance 210; above G and H are all preferable to illustrate said data processor how to process said detecting records to identify the status of object location as in or out said room 200 and how many said objects are associated with inside or outside said room 200 independently.

Finally, in order to describe the present invention with more demonstration effects, two practical applications of the above stated apparatus and method will be explained as follows.

The first application is applying said apparatus and method for conference management. For tracking conference attendants, there are two RFID gateways deployed at every entrance of each conference room independently. Said two RFID gateways identify conference attendants' movements by detecting RFID tags carried by them and send the captured RFID data to said data processor. Said data processor analyzes the captured RFID data based on some predefined configurations associated with the setting of said two RFID gateways for discovering the conference attendants' movements and locations. And then the accurate and useful real time information of the conference attendants' movements and locations could be used to manage the conference such as issue alert when a conference attendant is locating at unexpected locations, or issue alert when a speaker is still out of the conference room as his presentation is planned to begin in 10 minutes.

The second application is applying said apparatus and method for patient management. The object concerned by said apparatus and method are patients in a healthcare institute. Said two RFID gateways capture RFID data about patients' movements by said corresponding RFID interrogators which are deployed at every entrance of the healthcare institutes, and said data processor analyzes the captured RFID data to figure out the patients' particular behaviors within the healthcare institute. Therefore, the accurate and useful real time information of the patients' behaviors could give facilities for patient management such as issue alert once a patient is presenting at some unexpected locations.

In conclusion, the apparatus and method for identifying object movement and location provided by the present invention enable to track every personnel objects while they are presenting in a particular monitored zone with accurate and useful real time information of movement direction and location status for managing some activity, while said activity may be a seminar, a conference, an exhibition, a workshop, a show, or etc. In another word, the apparatus and method provided by the present invention enable to improve activity management with more accurate and more useful information.

The embodiments and examples set forth herein were presented in order to best explain the present invention and its particular application so as to enable those skilled in the art to make and/or use the present invention. However, those skilled in the art will recognize that the foregoing description and examples have been presented for the purposes of illustration and example only. The description as set forth is not intended to be exhaustive or to limit the present invention to the precise form disclosed. Many modifications and variations are possible in light of the above teaching without departing from the spirit of the forthcoming claims.

What is claimed is:

1. An apparatus for identifying object movement and location with RFID device, comprising
two RFID gateways constructed by at least one RFID interrogator independently, the first said RFID gateway forming a first interrogation zone inside an entrance of a monitored zone while the second said RFID gateway forming a second interrogation zone outside said entrance, each said RFID interrogator emitting a signal comprising a unique identifier associated with its corresponding RFID gateway;
a portable RFID tag carried by the object capable of receiving said signals emitted by said RFID interrogator, said portable RFID tag comprising means for reflecting back a response to said RFID interrogator according to the identifier of said received signal, said response reflected by said RFID tag comprising a unique code associated with the RFID tag;
a data processor connected with said RFID gateways capable of receiving said responses transmitted by said RFID interrogator, said data processor comprising means for processing the received response to determine which of said RFID gateway detecting said RFID tag at the time of the reception thereof, and analyzing the time of said first RFID gateway detecting said RFID tag earlier or later than said second RFID gateway to conclude said object movement as leaving or entering said entrance.

2. The apparatus as claimed in claim 1, wherein, said data processor further comprises means for recording said object location as inside or outside said monitored zone according to said first RFID gateway or said second RFID gateway detecting the last presence of said RFID tag.

3. The apparatus as claimed in claim 2, wherein, said data processor further comprises means for counting the number of said objects associated with inside or outside said monitored zone independently.

4. The apparatus as claimed in any one of claim 1-3, wherein, said RFID interrogator comprises one RFID reader and at least one antenna, or is an integrated RFID reader.

5. The apparatus as claimed in any one of claim 1-3, wherein, said RFID interrogator is fixed on a gateway mounting.

6. The apparatus as claimed in claim 5, wherein said gateway mounting is a tripod stand mounting, or an overhand mounting.

7. The apparatus as claimed in any one of claim 1-3, wherein, said data processor is connected with said two RFID gateways via a RFID middleware.

8. A method for identifying object movement and location with RFID device, comprising the step of
A. assigning the first and second RFID gateway a unique identifier independently;
B. locating at least one RFID interrogator associated with said first RFID gateway to establish corresponding first interrogation zone inside an entrance of a monitored zone, and locating at least one RFID interrogator associated with said second RFID gateway to establish corresponding second interrogation zone outside said entrance;
C. having said RFID interrogator emit signals comprising said unique identifier for reception by a portable RFID tag carried on the object;
D. reflecting back a response comprising a unique code associated with said RFID tag to said RFID interrogator according to the identifier of said received signal;
E. processing said response to determine which of said RFID gateway detecting said RFID tag at the time of the reception thereof;
F. analyzing the time of said first RFID gateway detecting said RFID tag earlier or later than said second RFID gateway to conclude said object movement as leaving or entering said entrance.

9. The method of claim 8, wherein, there is a step G after said step F for recording said object location as inside or outside said monitored zone according to said first RFID gateway or said second RFID gateway detecting the last presence of said RFID tag.

10. The method of claim 9, wherein, there is a step H after said step G for counting the number of said objects associated with inside or outside said monitored zone independently.

11. The method as claimed in any one of claim 8-10, wherein, said RFID interrogator comprises one RFID reader and at least one antenna, or is an integrated RFID reader.

12. The method as claimed in any one of claim 8-10, wherein, said RFID interrogator is fixed on a gateway mounting.

13. The method as claimed in claim 12, wherein said gateway mounting is a tripod stand mounting, or an overhand mounting.
